(19) United States
(12) Patent Application Publication
(10) Pub. No.: US 2011/0302486 A1
(43) Pub. Date: Dec. 8, 2011

(54) METHOD AND APPARATUS FOR OBTAINING THE EFFECTIVE CONTENTS OF WEB PAGE

(75) Inventor: Hailu JIA, Beijing (CN)

(73) Assignee: BEIJING RUIXIN ONLINE SYSTEM TECHNOLOGY CO., LTD, Beijing (CN)

(21) Appl. No.: 13/079,881

(22) Filed: Apr. 5, 2011

(30) Foreign Application Priority Data
Jun. 3, 2010 (CN) 201010196364.3

(51) Int. Cl. G06F 17/00

(52) U.S. Cl. 715/234

(57) ABSTRACT

A method for obtaining the effective contents of a web page comprises steps of: loading an HTML web page: converting the HTML web page into a corresponding DOM tree; finding a title label of effective contents according to the DOM tree, determining the text contents in the found title label as the title of the effective contents; searching sequentially for text labels in a <body> label of the DOM tree in accordance with label distances from short to long between the text labels and the title label, determining a text label having a text length larger than a predetermined length and some specific symbols related to the main text as a main text label, and then taking the text contents in the main text label as the main text of the effective contents. An apparatus corresponding to the method comprises corresponding modules.

### BACKGROUND OF THE INVENTION

(1) Field of the Invention

The invention relates to the field of Internet information processing, and particularly to a method and an apparatus for obtaining the effective contents of a web page.

(2) Description of Related Art

Recently, there exists a maximal information bank known by human on the Internet, on which a majority of information is expressed in an HTML (Hyper Text Mark-up Language) format. HTML is used for structuring information (such as title, section and list), which abundantly exhibits text, picture and other multimedia information. People may conveniently browse information in the HTML structure by means of a HTML reading tool—“browser”. However, from an aspect of information record, a HTML web page contains a mass of labels for structuring information, and may contain much ineffective information at the same time. Moreover, as various mobile terminals are vigorously developed, the requirement for a mobile terminal to obtain information from the Internet is much higher. If a mobile terminal directly accesses an HTML web page, the performance limitation of the mobile terminal may make the time connecting to HTML page longer and the connection speed slower, and especially the existence of a mass of ineffective information may cause the larger transmission flow of data, so that the time and cost of obtaining a web page for a user is higher. Thus, it is very important for a mobile terminal to correctly and rapidly extract valid information from an HTML web page.

The text information extracting techniques in prior art can only extract contents in a specific HTML label by the HTML label information. Specifically, in the text information extracting techniques, the structure of a web page need to be obtained beforehand and an extracting model need to be customized beforehand for an objective processed web page. However, if the structure of a web page can't be obtained beforehand, it is difficult to extract the text information.

### SUMMARY OF THE INVENTION

In one general aspect, the present invention provide a method and an apparatus for obtaining the effective contents of a web page, so as to simply and conveniently realize extraction of effective information from a web page in a common HTML structure.

According to an embodiment of the present invention, the method for obtaining the effective contents of a web page may comprise the steps of:

step S1: loading an HTML web page;

step S2: converting the HTML web page into a corresponding DOM tree;

step S3: finding a title label of effective contents according to the DOM tree, and determining the text contents in the found title label as the title of the effective contents;

step S4: searching sequentially for text labels in a <body> label of the DOM tree in accordance with label distances from short to long between the text labels and the title label, determining a text label which has a text length larger than a predetermined length and has specific symbols related to main text as a main text label, and then taking the text contents in the main text label as the main text of the effective contents.

According to an embodiment of the present invention, in the step S2, the corresponding DOM tree includes the labels related to the effective contents of the web page, wherein the unrelated information is deleted.

According to an embodiment of the present invention, the step S3 is performed by the steps of:

finding a <title> label in the HTML DOM tree;

searching in the <title> label for the text contents which are the same as or have the smallest edit distance to that in a <body> label;

determining the text contents as a title of the effective contents in case of finding the text contents, otherwise, searching in the <title> label for an effective text label having the shortest label distance from the <body> label, and taking the text contents in the effective text label as the title of the effective contents;

wherein the effective text label is a <h1> label, a <h2> label, or a label in which the font size of the text contents thereof is larger than a predetermined font size and the uninterrupted text in each of the children labels thereof exceed a predetermined value.

According to an embodiment of the present invention, the predetermined font size is five and the predetermined value is five characters.

According to an embodiment of the present invention, after finding the <title> label, the method may further comprise a filtering process step of processing the text labels in the <title> label by separation of hyphen and/or process of stop word so as to filter advertisement information therein and the information other than the title.

According to an embodiment of the present invention, the step S4 may further comprise a filtering step S41 of deleting a text label having the specific symbols related to advertisement information but not including the specific symbols related to the main text during the process of search for the text labels, and then searching for next text label.

According to an embodiment of the present invention, in the step S4, the specific symbols related to the main text comprise <p>, <br>, <div> or <table>, the predetermined length is 50 characters.

According to an embodiment of the present invention, the step S4 may further comprise a step S42 of judging whether the text contents in the text labels are the main text of the effective contents according to a ratio of link text length to non-link text length thereof during the process of search for the text labels; directly determining the text contents in the text label as the main text of the effective contents in case that the ratio is larger than zero and smaller than one, otherwise, determining that the text contents in the text label aren't determined as the main text of the effective contents.

According to an embodiment of the present invention, between the step S3 and the step S4, the method may further comprise a time extracting step S31 of firstly defining a regular expression of time information; searching for a label conforming to the regular expression of time information and having the shortest label distance from the title label according to the title label obtained through the step S3; and determining the contents in the searched label as the time of the effective contents.

According to an embodiment of the present invention, after the step S4, the method may further comprise a picture extracting step S5 of arranging the children labels of the main text label obtained through the step S4 in sequence; recording the first child label and the final child label; searching for an <img> label between the first child label and the final child label; and taking the contents in the searched <img> label as the picture of the effective contents.

According to an embodiment of the present invention, the apparatus for obtaining the effective contents of a web page may comprise:

a load module for loading an HTML web page;

a generation module for converting the HTML web page into a corresponding DOM tree;

a title extracting module for finding a title label of the effective content according to the DOM tree and taking the text contents in the title label as the title of the effective contents;

a text extracting module for searching sequentially for text labels in a <body> label of the DOM tree according to the label distance from short to length between the text labels and the title label, determining a text label having the specific symbols related to the main text and having a text length larger than a predetermined length as a main text label, and taking the text contents in the main text label as the main text of the effective contents.

According to an embodiment of the present invention, the title extracting module comprises:

a <title> label searching unit for finding a <title> label in the HTML DOM tree; a title determining unit for searching in the <title> label for the text contents which are the same as or have the smallest edit distance to that in the <body> label, determining the text contents as a title of the effective contents in case of finding the text contents, otherwise, searching in the <title> label for an effective text label having the shortest label distance from the <body> label, and taking the text contents in the effective text label as the title of the effective contents;

wherein the effective text label is a <h1> label, a <h2> label, or a label in which the font size of the text contents thereof is larger than a predetermined font and the uninterrupted texts in each of the children labels thereof exceed a predetermined value.

According to an embodiment of the present invention, between the <title> label searching unit and the title determining unit, the title extracting module may further comprise a filtering process unit for processing the text labels in the <title> label by separation of hyphen and/or process of stop word so as to filter advertisement information therein and the information other than the title.

According to an embodiment of the present invention, the text extracting module may further comprise a filtering unit for deleting a text label having the specific symbols related to advertisement information but not including the specific symbols related to the main text during the process of search for the text labels, and then searching for next text label.

According to an embodiment of the present invention, the text extracting module may further comprise a ratio judgment unit for judging whether the text contents in the text label are the main text according to a ratio of link text length to non-link text length thereof during the process of search for the text labels, directly determining the text contents in the text label as the main text of the effective contents in case that the ratio is larger than zero and smaller than one, otherwise, determining the text contents in the text labels aren't the main text of the effective contents.

According to an embodiment of the present invention, the apparatus may further comprise a time extracting module for defining a regular expression of time information, searching for a label conforming to the regular expression of time information and having the shortest label distance from the title label according to the title label obtained through the title extracting module, and then determining the contents in the searched label as time of the effective contents.

According to an embodiment of the present invention, the apparatus may further comprise a picture extracting module for arranging the children labels of the main text label obtained through the text extracting module in sequence, recording the first child label and the final child label, and then searching for an <img> label in the first child label and the final child label, taking the contents in the searched <img> label as the picture of the effective contents.

The present invention extracts automatically information, such as the title, the time, the main text, the picture, and so on of a web page such as HTML web page. Therefore, the present invention can avoid customization of an extracting model for each of the web pages in prior art and improve degree of automation of extracting a HTML web page.

The above and other objects, features and advantages of the present invention will become more apparent through the following description of preferred embodiments with reference to the accompanying drawings.

### BRIEF DESCRIPTION OF THE DRAWINGS

FIG. 1 is a schematic flow chart of a method for obtaining the effective contents of a web page according to an embodiment of the present invention;

FIG. 2 is a schematic structural view of an HTML Document Object Model according to an embodiment of the present invention;

FIG. 3 is a schematic view showing a label distance in the HTML Document Object Model according to an embodiment of the present invention;

FIG. 4 is a schematic flow chart of obtaining a news web page according to an embodiment of the present invention;

FIG. 5 is a schematic structure view of an apparatus for obtaining the effective contents of a web page according to an embodiment of the present invention.

### DETAILED DESCRIPTION OF THE PREFERRED EMBODIMENTS

The embodiments of the present invention will be described in detail thereafter. It should be noted that the embodiments described herein are intended to illustrate but not to limit the present invention.

The present invention investigates location information, specific result information, and label information of various text objects in a web page according to the overall structure of the effective contents of a web page to be extracted, so that it is possible to realize automatic extraction function of text from web page. Because a web page conforms to an HTML DOM (Document Object Model) tree structure, a web page with the effective contents (such as a news web page) includes many types of labels which are divided into a function label of a web page, an advertisement label, and a news content label in a general logical sense. The information extraction of a web page means extraction of the effective contents (for example, news contents) from the web page. The name and property of the label is not enough for judgment of the function of a label, other information are required. Therefore, according to one embodiment of the present invention, judgment of the logical function of a label comprises judging in labels the text length of a text label and the label location of a label in the overall DOM tree of an HTML web page, so as to realize the common extraction function of the effective texts in a web page. According to one embodiment, the present invention may be applied to extract a web page with the effective contents (such as a news web page, a blog web page) and may filter an advertisement or other useless text contents.

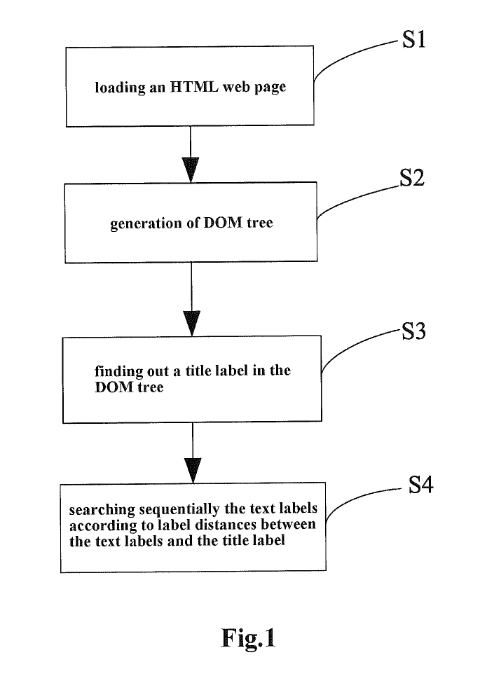

According to one embodiment, as shown in FIG. 1, the present invention employs the following steps to extract the effective contents of a web page, including:

step S1: loading an HTML web page;

step S2: converting the HTML web page into a corresponding HTML DOM tree;

step S3: finding a title label of the effective contents according to the HTML DOM tree, and determining the text contents in the found title label as the title of the effective contents;

step S4: searching sequentially for text labels in a <body> label of the DOM tree in accordance with the label distances from short to long between the text labels and the title label, determining a text label which has a text length larger than a predetermined length and has specific symbols related to the main text as a main text label, and then taking the text contents in the main text label as the main text of the effective contents.

One embodiment of the above steps will be described in detail with reference to the accompanying drawings.

In the step S1, an HTML web page is loaded. For purpose of assisting a mobile device or terminal to process information of an HTML web page so as to improve the internet connection speed of a mobile terminal (such as a mobile phone) and the ability of obtaining the required information rapidly, a filtration for the web pages to filter useless information (such as advertisement information) is comprised before a web page is input to a mobile terminal, and thereby the required effective information (for example, information of a news web page) is obtained.

In the step S2, the loaded HTML web page is converted into the corresponding HTML DOM tree structure. Because HTML is a format language, the text information is located in HTML labels which provide adorning to the information, such as information location, information showing manner, and so on. In an HTML format document, the labels constitute a DOM tree structure from top to bottom. The following rules are made for HTML labels and text contents according to W3C DOM standards:
The overall document is a document node;
Each of the HTML labels is an element node;
A text included in a HTML element is a text node;
Each of the HTML properties is a property node.

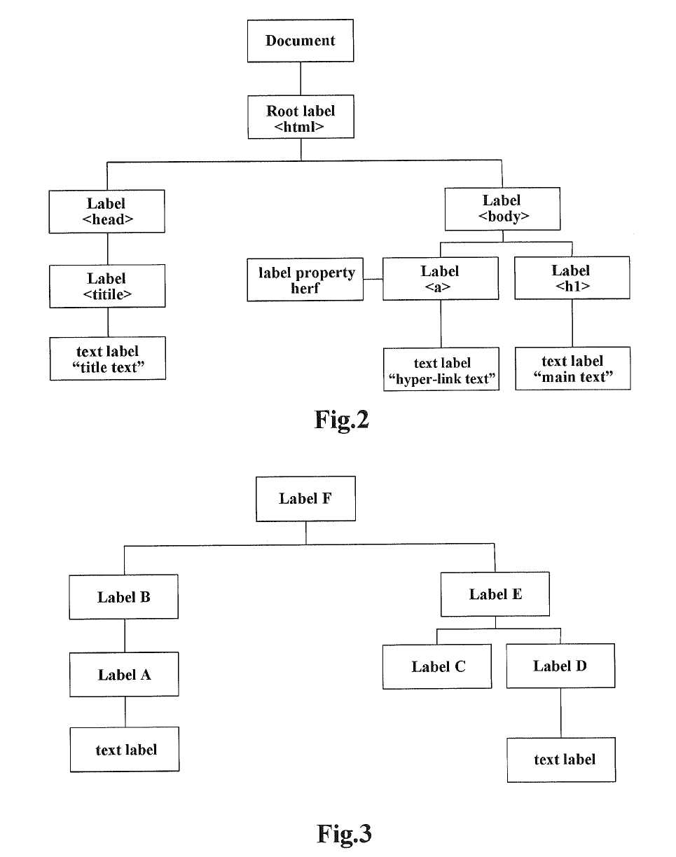

As shown in FIG. 2, the HTML DOM structure is a tree structure constituted of many text nodes and label nodes, wherein some labels, such as a <head> label, a <body> label and a <table> label, and so on, are further provided under a root label. The contents (such as a title of a web page, key words) are located in a pair of <head> labels. For example, in the following HTML example, a pair of <title> labels is provided in a pair of <head> labels, wherein the contents in the <title> labels are a title of the effective contents (such as a title of a news page). Moreover, the contents in the pair of <body> labels are, for example, text or picture of the effective contents.

An exemplary view of HTML labels is as follow:

<html>

<head>

<title>

title text

</title>

</head>
<body>

<a herf>

hyperlink text

</a>
<h1>

main text

</h1>

</body>

</html>

When the HTML DOM tree is generated, the DOM tree may be specifically constituted according to the extracted contents. For example, if the extracted contents only relate to a news web page, only the labels related to the news web page are considered, whereas other labels unrelated to the news web page are directly omitted.

After the HTML DOM tree is generated, the step S3 is performed to extract a title of the effective contents, i.e. a pair of <title> labels is found from the above HTML DOM tree structure and the text contents in the found title labels are regarded as the title of the effective contents.

In detail, after the <title> labels are found, the text labels (an h1 label or an h2 label) in the pair of <title> labels are filtered. Because a normal news web page may include character string of a news title, and an h1 or h2 child label is further included to decorate the character string of the news title in some websites, the texts in the pair of <title> labels may be processed to obtain the news title. For example, processing the text labels in the <title> label is made by separation of hyphen and/or process of stop word so as to filter advertisement information therein and the information other than the title. For example, in a web page “http://news.xinhuanet.com/world/2010-04/26/c_{—}1255760.html”, the characters string in the <title> labels are “Could Service for the World's Fair Stands the Test of 70,000,000 People's Visits?_International Channel_XinHuaNet”, wherein the contents “Could Service for the World's Fair Stands the Test of 70,000,000 People's Visits?” are the required news, the hyphen character is the underline “_”, and stop word are “International Channel” and “XinHuaNet”. Then, a match search is performed. Specifically, the text contents in the <title> labels which are the same as or have the smallest edit distance to that in the <body> labels are searched for, and then the searched text contents are determined as a title of the effective contents. Here, it shall be explained that the so-called edit distance means the measurement of similarity between two character strings, i.e. the edit distance is the minimum times of edit operation that a character string is converted into another character string. The allowed edit operation includes an operation of converting a character into another character, an operation of inserting a character, or an operation of deleting a character. The smaller the edit distance between two character strings is, the higher the similarity of the two character strings is.

If the above match search in the <title> labels fails, a title of the effective contents may be obtained by another method which is to search for an effective text label with the shortest label distance from the <body> labels and to take the texts in the effective text label as a title of a web page (for example, a news page).

Since a text label is the main carrier of text information in a HTML web page and from the exhibition sense of a web page the main representation form of the text information includes the length of an uninterrupted text section and the font size of a character, the effective text label herein according to one embodiment of the present invention satisfies any one of the following conditions: 1) the length of an uninterrupted text in the text content of non-<a> hyperlink label is beyond a predetermined value, for example, 25 characters (Chinese characters or foreign words); 2) the label is a <h1> label or a <h2> label, or a label in which the font size of the text contents thereof is larger than a predetermined font size, for example font size 5, and the uninterrupted texts in each of the children labels thereof exceed a predetermined value, for example, 5 characters (Chinese characters or foreign words).

The label distance between an effective text label and other label is calculated on basis of the relation of their exhibition location in the DOM tree structure, wherein the relation of exhibition location between two labels is classified into the following three cases or is applied to the following three rules, as shown in FIG. 3 and table 1.

Case 1: In case that a label is a child node label and another label is a father node label, the label distance between the child node label and the father node label is zero. For example, the label distance between label A and B is zero;

Case 2: In case that two labels are in the same level having the same father node, their label distance is equal to the order difference in the children list of their same father node. For example, the label distance between label C and label D is −1;

Case 3: In case that two labels have different father nodes respectively, their label distance is equal to the label distance between their forefathers which are in the same level. For example, the label distance of label A and D is equal to the label distance between their father node B and father node E. Because the label distance between label B and label E is equal to −1, the label distance between label A and label D is also equal to −1.

TABLE 1

| start label | end label | label distance | rule |
|---|---|---|---|
| label A | label B | 0 | case 1 |
| label B | label A | 0 | case 1 |
| label A | label A | 0 | case 2 |
| label C | label D | −1 | case 2 |
| label D | label C | 1 | case 2 |
| label A | label E | −1 | case 3 |
| label E | label A | 1 | case 3 |
| label A | label D | −1 | case 3 |
| label D | label A | 1 | case 3 |

An effective text label which has the shortest label distance from a <body> label is found by comparing the label distances calculated according to the above-mentioned three cases. Which effective text label is judged to have the shortest label distance from the <body> label according to the comparison result, the text of which effective text label is regarded as the title contents.

Next, in step S4, the main text of the effective contents is extracted. The text labels in the <body> label of the HTML DOM tree structure are searched for in sequence according to the label distance from short to long from the title label. A text label which has a text length larger than a predetermined length (for example, 50 characters) and has specific symbols related to the main text is regarded as a main text label, and then the text contents in the main text label are determined as the main text.

In the step S4, the specific symbols may be, for example, <p>, <br>, <div> or <table> and so on, in which the contents are relative to the main text. The step S4 further includes the filtering step S41 of filtering the advertisement information. In the step S41, if the found effective text label includes other specific symbols other than the above-mentioned symbols, the contents in the found effective text label are directly determined as advertisement information and deleted, and then next text label is judged. For example, if a certain effective text label includes a <a> label, but doesn't include a <br> label, the contents in the effective text label are directly determined as advertisement information and deleted. Due to deletion of the label corresponding to advertisement information in the above process, the repetitive judgment for the advertisement information is avoided in the next process of search for/judgment of the main text, and the process of extracting the main text is expedited.

In the step S4, another method is used for judgment of the main text. Another method is to judge whether the text contents in an effective text label are the main text by the ratio of the length of link text to the length of non-link text. If the ratio is very small (larger than 0 and smaller than 1), it shows that the non-link text in the text contents is more than the link text, thus the text contents in the effective text label are directly determined as the main text. If the ratio is very large (larger than 1), it shows that the non-link text in text is much less than the link text, thus it is directly determined that the text contents in the effective text label isn't the main text.

Except for extraction of the title and the main text of the effective contents, according to one embodiment of the present invention, extraction of time and/or picture of the effective contents is/are performed.

For example, a time extracting step S31 may be included between the steps S3 and S4. In the step S31, firstly a regular expression of time information is defined. A label conforming to the regular expression of time information and having the shortest label distance from the title label is searched for according to the title label obtained through the step S3, and then the contents in the searched label are determined as the time. If there is no a title label which has been determined, a label conforming to the regular expression of time information and having the shortest label distance from the <body> label is searched for and then the contents in the searched label are determined as the time.

After the step S4, a picture extracting step S5 may be included. In the step S5, the children labels of the text label obtained through the step S4 are arranged in sequence, a first child label and a final child label are recorded, and then an <img> label is searched for between the first child label and the final child label, in which the contents is made as the picture of the effective contents.

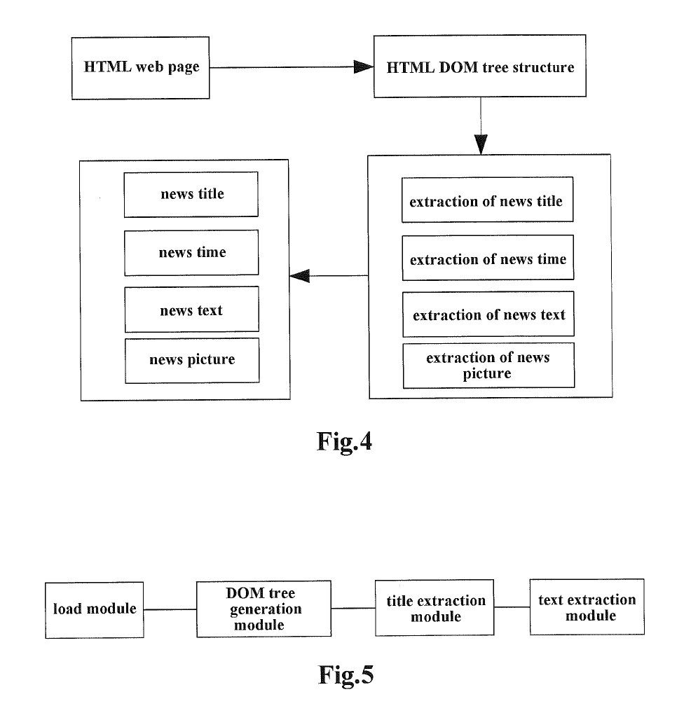

The method of the present invention is illustrated taking obtaining the news contents for an example. As shown in FIG. 4, firstly, an HTML web page in a portal website is loaded and converted into the corresponding DOM tree structure; then, the extraction of the news title and news text is performed; because the time effectiveness of a news page is very important for the news, the time extraction of the news page may be included in the extracting process; and because the current affairs are illustrated in a form of combination of text and picture, the picture extraction of the news page may be included in the extracting process. The extracting method of the respective parts of the news web page is described in detail thereafter.

1. the extracting method of news title includes:

1) the <title> label of news page is judged. If the text labels in the <title> label are processed by separation of hyphen and process of stop word, thereafter, a text label which is the same as or has the smallest edit distance to that in a <body> label is searched for in the <title> label, the searched text label will be determined as the news title;

2) if the search according to the rule 1) fails, an effective text label having the shortest label distance from the <body> label is searched for, and the text contents in the searched effective text label are determined as the news title.

2. The extracting method of the news time includes:

1) a regular expression of time information is defined;

2) if the label of the news title has been obtained, a text label conforming to the regular expression of time information and having the shortest label distance from the label of the news title is searched for, and the searched text label will be determined as the label of the news time;

3) if there is no a determined label of the news title, a text label conforming to the regular expression of time information and having the shortest label distance from the <body> label is searched for, and then the searched text label will be determined as the label of the news time.

3, The extracting method of the news text includes:

1) a label having a shortest label distance from the effective text label and including a text of larger than about 50 characters therein is searched for in the <body> label, and then the searched label will be determined as the root label of the news text;

2) all text contents of all the text labels in the root label of the news text are extracted as the main text of the news.

4. the extracting method of the news picture includes:

1) the children effective labels in the root label of the news text are arranged in sequence, and a start effective text label and an end effective text label are recorded;

2) an <img> label between the start effective text label and the end effective is searched for, and then the searched <img> label will be determined as a label of the effective news picture, the contents in the label of the news picture are extracted as the picture of the news web page.

Information of all kinds of news web pages may be extracted by the above-mentioned steps without designation of specific extracting modules for the different web page structures respectively. Therefore, the automatic degree of extracting the information of web page is improved and the operation amount of process in extracting the information of a web page is reduced.

According to one embodiment of the present invention, an apparatus for obtaining the effective contents of a web page may be provided comprising:

a load module for loading a HTML web page;

a generation module for converting the HTML web page into a corresponding HTML DOM tree;

a title extracting module for finding a title label of the effective contents according to the HTML DOM tree and taking the text contents in the title label as the title of the effective contents;

a text extracting module for searching sequentially for the text labels in a <body> label of the HTML DOM tree according to the label distance from short to length between the text labels and the title label, determining a text label having the specific symbols related to the main text and having a text length larger than a predetermined length as a main text label, and taking the text contents in the main text label as the main text of the effective contents.

Further, the title extracting module may include: an <title> label searching unit for finding a <title> label in the HTML DOM tree; a title determining unit for searching in the <title> label for the text contents which are the same as or have the smallest edit distance to that in the <body> label, determining the searched text contents as a title of the effective contents if the search succeeds, otherwise, searching in the <title> label for an effective text label having the shortest label distance from the <body> label, and taking the text contents in the effective text label as the title of the effective contents.

Wherein the effective text label is a <h1> label, a <h2> label, or a label in which the font size of the text contents is larger than a predetermined font, and the uninterrupted texts in each of the children labels thereof exceed a predetermined value.

Between the <title> label searching unit and the title determining unit, the title extracting module may further include a filtering process unit for processing the text labels in the <title> label by separation of hyphen and/or process of stop word so as to filter advertisement information therein and the information other than the title.

The text extracting module may further include a filtering unit for deleting a text label having the specific symbols related to advertisement information but not including the specific symbols related to the main text, and then searching for next text label thereafter.

The text extracting module may further include a ratio judgment unit for judging whether the text contents in the text labels are the main text according to a ratio of link text length to non-link text length thereof in the process of search for the text labels, wherein the text contents in the text labels are determined directly as the main text in case that the ratio is larger than zero and smaller than one, otherwise, it is determined that the text contents in the text labels are not the main text of the effective contents.

The apparatus may further include a time extracting module for defining a regular expression of time information, searching for a label conforming to the regular expression of time information and having the shortest label distance from the title lable according to the title label obtained through the title extracting module, and then determining the contents in the searched label as time of the effective contents.

The apparatus may further include a picture extracting module for arranging the children labels of the effective text label obtained through the text extracting module in sequence, recording the first child label and the final child label, and then searching for an <img> label between the first child label and the final child label, and taking the contents in the searched <img> label as the picture of the effective contents.

The method according to one embodiment of the present invention may be implemented through use of a computer, server or any other kinds of processing devices known in the art. For example, the computer performs the steps of the above method by performing one or any combination of instructions, programs, software and data stored in a memory, a hard disk, a removable disk, a CD-ROM, or any other kinds of storage media known in the art.

The apparatus according to one embodiment of the present invention may be a computer system, a server or any other devices which may perform the steps of the above method. The modules such as the load module and so on, and the units such as the <title> label searching unit and so on may be the components, logic circuits or other parts of the computer system, server which may have the corresponding function.

Although the present invention has been described with reference to several typical embodiments, it shall be understood that the terms used herein is to illustrate rather than limit the present invention. The present invention can be implemented in many particular embodiments without departing from the spirit and scope of the present invention, thus it shall be appreciated that the above embodiments shall not be limited to any details described above, but shall be interpreted broadly within the spirit and scope defined by the appended claims. The appended claims intend to cover all the modifications and changes falling within the scope of the appended claims and equivalents thereof.

What is claimed is:

1. A method for obtaining the effective contents of a web page, comprising the steps of:
step S1: loading an HTML web page;
step S2: converting the HTML web page into a corresponding DOM tree;
step S3: finding a title label of the effective contents according to the DOM tree, and determining the text contents in the found title label as the title of the effective contents;
step S4: searching sequentially for text labels in a <body> label of the DOM tree in accordance with the label distances from short to long between the text labels and the title label, determining a text label which has a text length larger than a predetermined length and has specific symbols related to the main text as a main text label, and then taking the text contents in the main text label as the main text of the effective contents.

2. The method for obtaining the effective contents of a web page according to claim 1, wherein in the step S2, the corresponding DOM tree includes the labels related to the effective contents of the web page, wherein the unrelated information is deleted.

3. The method for obtaining the effective contents of a web page according to claim 1, wherein the step S3 is performed by the steps of:
finding a <title> label in the DOM tree;
searching in the <title> label for the text contents which are the same as or have the smallest edit distance to that in a <body> label;
determining the searched text contents as the title of the effective contents if the search succeeds, otherwise, searching in the <title> label for an effective text label having the shortest label distance from the <body> label, and taking the text contents in the searched effective text label as the title of the effective contents;
wherein the effective text label is a <h1> label, a <h2> label, or a label in which the font size of the text contents thereof is larger than a predetermined font size and the uninterrupted texts in each of the children labels thereof exceed a predetermined value.

4. The method for obtaining the effective contents of a web page according to claim 3, wherein the predetermined font size is five and the predetermined value is five characters.

5. The method for obtaining the effective contents of a web page according to claim 3, wherein after finding the <title> label the method further comprises a filtering process step of processing the text labels in the <title> label by separation of hyphen and/or process of stop word so as to filter advertisement information therein and the information other than the title.

6. The method for obtaining the effective contents of a web page according to claim 1, wherein the step S4 further comprises a filtering step S41 of: deleting a text label having the specific symbols related to advertisement information but not including the specific symbols related to the main text during the process of search for the text labels, and then searching for next text label.

7. The method for obtaining the effective contents of a web page according to claim 1, wherein in the step S4, the specific symbols related to the main text comprise <p>, <br>, <div> or <table>, the predetermined length is 50 characters.

8. The method for obtaining the effective contents of a web page according to claim 1, wherein the step S4 further comprises a step S42 of:
judging whether the text contents in the text label are the main text of the effective contents according to a ratio of link text length to non-link text length thereof during the process of search for the text labels;
directly determining the text contents in the text label as the main text of the effective contents in case that the ratio is larger than zero and smaller than one, otherwise, determining that the text contents in the text label aren't the main text of the effective contents.

9. The method for obtaining the effective contents of a web page according to claim 1, wherein between the step S3 and the step S4 the method further comprises a time extracting step S31 of:
defining a regular expression of time information;
searching for a label conforming to the regular expression of time information and having the shortest label distance from the title label according to the title label obtained through the step S3; and
determining the contents in the searched label as the time of the effective contents.

10. The method for obtaining the effective contents of a web page according to claim 1, wherein after the step S4 the method further comprises a picture extracting step S5 of:
arranging the children labels of the main text label obtained through the step S4 in sequence;
recording the first child label and the final child label;
searching for an <img> label between the first child label and the final child label; and
taking the contents in the searched <img> label as the picture of the effective contents.

11. An apparatus for obtaining the effective contents of a web page, the apparatus comprising:
a load module for loading an HTML web page;
a generation module for converting the HTML web page into a corresponding DOM tree;
a title extracting module for finding a title label of the effective contents according to the DOM tree and taking the text contents in the title label as the title of the effective contents;
a text extracting module for searching sequentially for text labels in a <body> label of the DOM tree in accordance with the label distance from short to long between the text labels and the title label, determining a text label having the specific symbols related to the main text and having a text length larger than a predetermined length as a main text label, and taking the text contents in the main text label as the main text of the effective contents.

12. The apparatus for obtaining the effective contents of a web page according to claim 11, wherein the title extracting module comprises:
a <title> label searching unit for finding a <title> label in the DOM tree;
a title determining unit for searching in the <title> label for the text contents which are the same as or have the smallest edit distance to that in the <body> label, determining the searched text contents as the title of the effective contents if the search succeeds, otherwise, searching in the <title> label for an effective text label having the shortest label distance from the <body> label, and taking the text contents in the effective text label as the title of the effective contents;
wherein the effective text label is a <h1> label, a <h2> label, or a label in which the font size of the text contents thereof is larger than a predetermined font and the uninterrupted texts in each of the children labels thereof exceed a predetermined value.

13. The apparatus for obtaining the effective contents of a web page according to claim 12, wherein between the <title> label searching unit and the title determining unit, the title extracting module further comprises a filtering process unit for processing the text labels in the <title> label by separation of hyphen and/or process of stop word so as to filter advertisement information therein and the information other than the title.

14. The apparatus for obtaining the effective contents of a web page according to claim 11, wherein the text extracting module further comprises a filtering unit for deleting a text label having the specific symbols related to advertisement information but not including the specific symbols related to the main text during the process of search for the text labels, and then searching next text label.

15. The apparatus for obtaining the effective contents of a web page according to claim 11, wherein the text extracting module further comprises a ratio judgment unit for judging whether the text contents in the text label are the main text according to a ratio of link text length to non-link text length thereof during the process of search for the text labels, directly determining the text contents in the text label as the main text of the effective contents in case that the ratio is larger than zero and smaller than one, otherwise, determining the text contents in the text labels aren't the main text of the effective contents.

16. The apparatus for obtaining the effective contents of a web page according to claim 11, wherein the apparatus further comprises a time extracting module for defining a regular expression of time information, searching for a label conforming to the regular expression of time information and having the shortest label distance from the title label according to the title label obtained through the title extracting module, and then determining the contents in the searched label as time of the effective contents.

17. The apparatus for obtaining the effective contents of a web page according to claim 11, wherein the apparatus further comprises a picture extracting module for arranging the children labels of the main text label obtained through the text extracting module in sequence, recording the first child label and the final child label, and then searching for an <img> label between the first child label and the final child label, and taking the contents in the searched <img> label as the picture of the effective contents.
